(19) United States
(12) Patent Application Publication
(10) Pub. No.: US 2026/0352595 A1
(43) Pub. Date: Nov. 5, 2026

(54) AI/ML DATA TRANSPORT MECHANISMS IN THE MOBILE CORE NETWORK

(71) Applicant: AT&T Intellectual Property I, L.P., Atlanta, GA (US)

(72) Inventors: Jyotirmoy Banik, Round Rock, TX (US); Milap Majmundar, Austin, TX (US); Salam Akoum, Austin, TX (US); Rajendra Prasad Kodaypak, Sammamish, WA (US)

(73) Assignee: AT&T Intellectual Property I, L.P., Atlanta, GA (US)

(21) Appl. No.: 19/197,066

(22) Filed: May 2, 2025

(51) Int. Cl. H04L 45/00

(52) U.S. Cl. CPC H04L 45/70; H04L 45/22

(57) ABSTRACT

Aspects of the subject disclosure may include, for example, receiving artificial intelligence and machine learning (AI/ML) data from a network element in a radio access network (RAN) for communication to a core network (CN), determining a transport pathway for the AI/ML data based on one or more factors, wherein the determining a transport pathway comprises selecting a selected transport pathway from among a plurality of available pathways, the plurality of available pathways including a user plane path, a control plane path, and a management plane path, and transmitting the AI/ML data from the network element to the CN over the selected transport pathway. Other embodiments are disclosed.

### FIELD OF THE DISCLOSURE

The subject disclosure relates to a method and system for transporting artificial intelligence and machine learning (AI/ML) data from a radio access network (RAN) to a core network of a mobile communications system.

### BACKGROUND

Developments are under way to enable the transfer of AI/ML data from a RAN to a core network in a mobile communications system. Not all data transport mechanisms are supported in current implementations, however.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C is a block diagram illustrating conventional communication interfaces in a mobile communications network.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a method and system for efficiently transporting AI/ML data from a radio access network (RAN) to a core network (CN) by leveraging existing network interfaces and paths, minimizing disruption to current network architectures. The disclosure introduces functions of an Intelligent Traffic Steering and Throttling Agent (ITSTA) that dynamically selects the optimal transport pathway based on factors such as device type, data volume, a time of day, a transport pathway priority, and network performance metrics, while also monitoring and managing network load to ensure stability. This approach supports seamless integration with traditional and O-RAN architectures, enhancing scalability and cost-effectiveness in AI/ML data management within mobile networks. Other embodiments are described in the subject disclosure.

One or more aspects of the subject disclosure include receiving artificial intelligence and machine learning (AI/ML) data from a network element in a radio access network (RAN) for communication to a core network (CN), determining a transport pathway for the AI/ML data based on one or more factors, wherein the determining a transport pathway comprises selecting a selected transport pathway from among a plurality of available pathways, the plurality of available pathways including a user plane path, a control plane path, and a management plane path, and transmitting the AI/ML data from the network element to the CN over the selected transport pathway.

One or more aspects of the subject disclosure include receiving artificial intelligence and machine learning (AI/ML) data from a network element in a radio access network (RAN), the AI/ML data being generated by at least one of user equipment or a base station, the RAN being in data communication with a core network (CN) over a user plane path and a control plane path, determining a selected transport pathway for conveying the AI/ML data from the RAN to CN, wherein the determining the selected transport pathway comprises selecting one of the user plane path and the control plane path, and transmitting the AI/ML data from the network element to the CN over the selected transport pathway.

One or more aspects of the subject disclosure include receiving artificial intelligence and machine learning (AI/ML) data from a network element in a radio access network (RAN), the AI/ML data being generated by at least one of user equipment or a base station, the RAN being in data communication with a core network (CN) over a user plane path and a control plane path, determining a selected transport pathway for conveying the AI/ML data from the RAN to the CN, wherein the determining the selected transport pathway comprises selecting one of the user plane path and the control plane path, transmitting, by the processing system, the AI/ML data from the network element to the CN over the selected transport pathway, and throttling communication of the AI/ML data to improve overall data communication performance, wherein the throttling is responsive to performance metrics for data communication between the RAN and the CN.

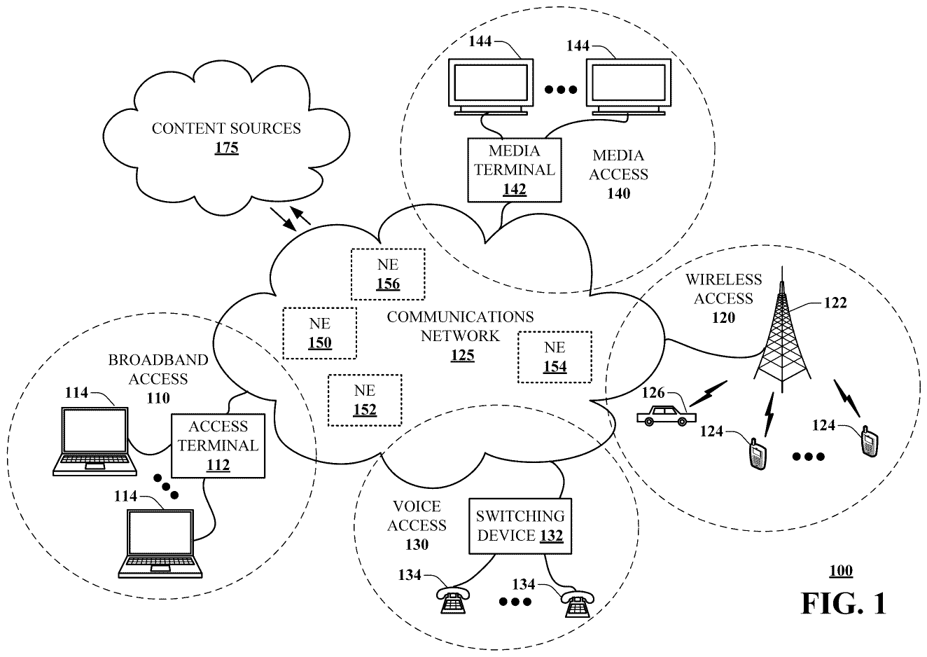

Referring now to FIG. 1, a block diagram is shown illustrating an example, non-limiting embodiment of a system 100 in accordance with various aspects described herein. For example, system 100 can facilitate in whole or in part transporting AI/ML data between an access network such as a radio access network and a core network using existing interfaces and paths. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In recent years, the availability of large amounts of data and cost effective compute power have led to increased usage of AI/ML models on the devices and on the network infrastructure to achieve better optimization compared to the legacy non-AI/ML models. Most of these AI/ML based solutions are implementation-based, for instance, optimizing and improving operations of applications, devices, chipsets, etc. and may not require signaling or inputs from cellular networks. Thus, the AI/ML based solutions have not been part of the cellular network standardization.

Current and future networks include features to enable improved support of AI/ML based algorithms for enhanced performance and/or reduced complexity/overhead of the 5G system. AI/ML in 5G however is not native, in the sense that the introduction of features, and corresponding signaling, related to AI/ML models at the UE side or the network side, is retrofitted to the existing 5G network and the 5G network architecture. Further, AI/ML models used in cellular networks have a definite life cycle and need to be replaced or updated from time to time. Still further, AI/ML models must be trained and training even a simple AI/ML model requires collecting large amounts of historical data from one or multiple entities across the network. Accordingly, AI/ML data traffic may be managed by a dedicated AI/ML plane (AMP), which operates independently of and in parallel with the control and user planes of a mobile network, ensuring proper handling of AI/ML data.

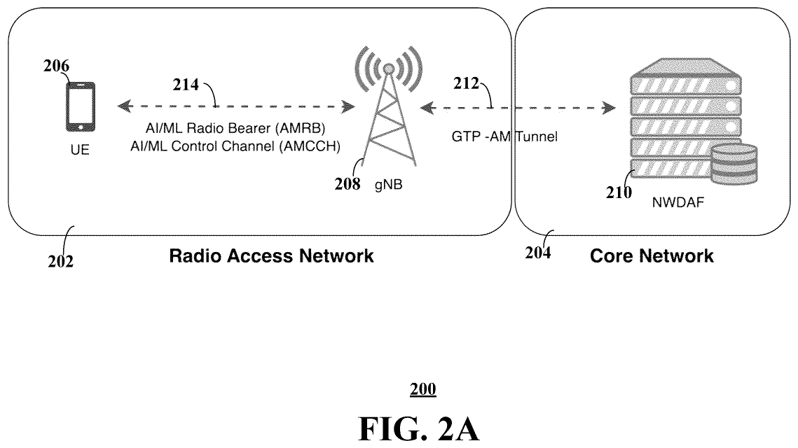

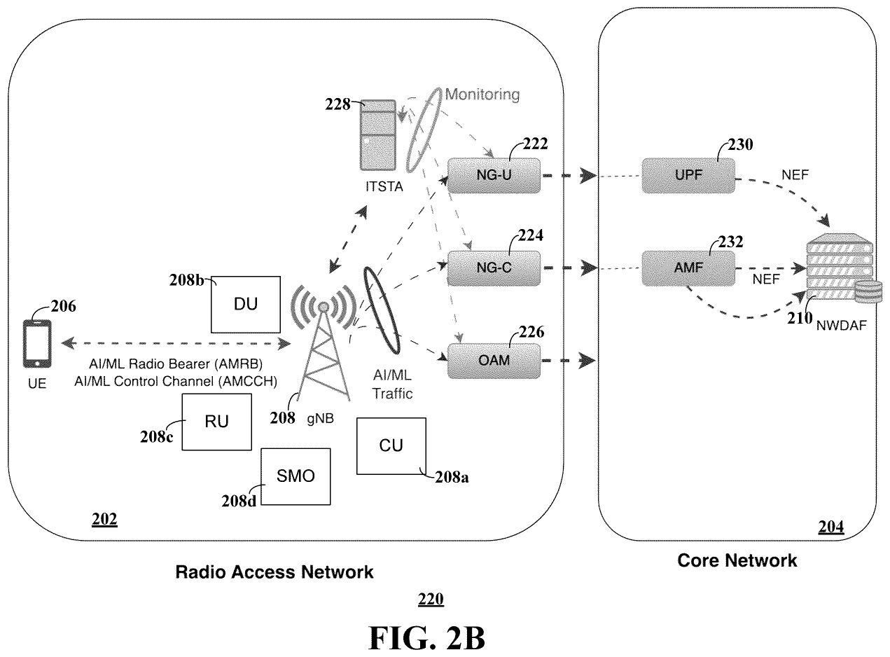

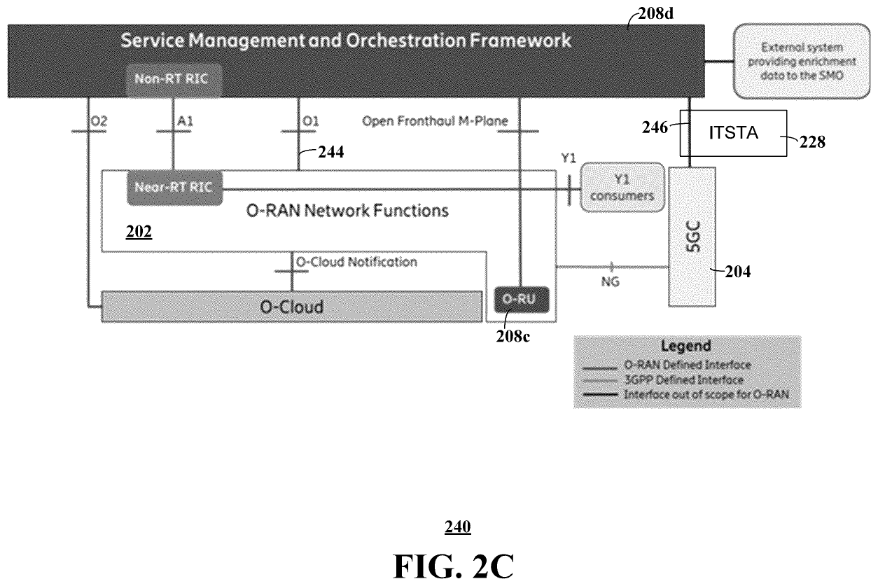

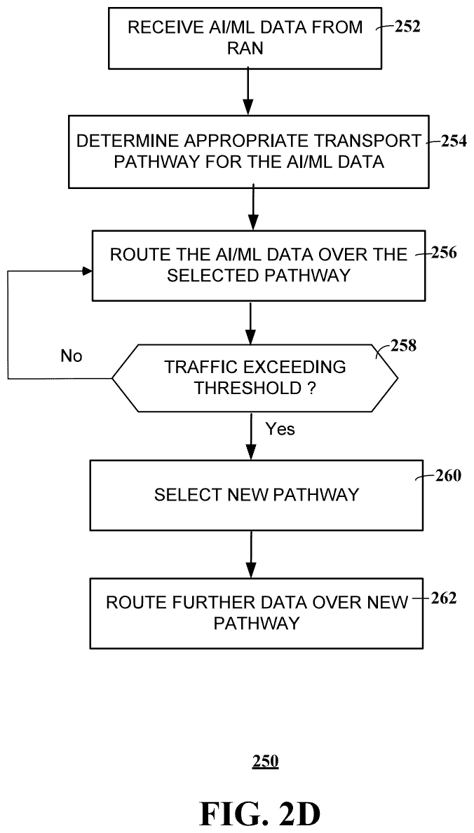

FIG. 2A is a block diagram illustrating an example, non-limiting embodiment of a system 200 functioning within the communication network of FIG. 1 in accordance with various aspects described herein. The system 200 illustrates portions of a mobile communications network including a radio access network (RAN) 202 and a core network (CN) 204. The RAN 202 provides radio communications for user devices such as user equipment (UE) 206. The RAN 202 includes base stations or infrastructure equipment such as gNodeB (gNB) 208. The gNB 208 provides radio communication services to user devices in a service area served by the gNB 208. The core network 204 provides a number of functions including authorization and mobility, session management and a user plane function. In particular, the core network 204 includes a Network Data Analytics Function (NWDAF) 210. Other functions of the core network 204 not illustrated in the example of FIG. 2A may include a Data Collection Coordination Function (DCCF) and an Analytics Data Repository Function (ADRF).

A novel mechanism has been identified to carry artificial intelligence and machine learning (AI/ML) data on an AI/ML plane (AMP) from the radio access network (RAN) to the core network (CN) in a mobile communication system such as the system 200. A new type of radio bearer channel called AI/ML radio bearers (AMRB) may be used for carrying the AI/ML data collection traffic over a connection 214 between the UE 206 and the gNB 208. The AMRBs are used to transmit user data between the gNB and the UE. The gNB maps quality of service (QoS) flows (each identified by QoS Flow Identifiers (QFIs)) to appropriate or corresponding AMRBs based on the QoS parameters received from the core network, when applicable. The present application incorporates by reference the entirety of co-pending U.S. patent application Ser. No. 19/054,063, filed on Feb. 14, 2025, entitled “QUALITY OF SERVICE REQUIREMENTS IMPLEMENTATION FOR ARTIFICIAL INTELLIGENCE/MACHINE LEARNING (AI/ML) DATA TRAFFIC IN A RADIO ACCESS NETWORK” (having Attorney Docket No. 2024-2281_7785-3822), which is commonly assigned with the present application and is incorporated herein in its entirety by this reference. This co-pending application provides detailed descriptions and embodiments related to managing the QoS requirements using the AMRBs via the AMP. In one or more embodiments, the AMRB is mapped to a logical channel which can be classified as a traffic channel or a control channel. The logical channel is referred to as AI/ML Control Channel (AMCCH). The present application further incorporates by reference the entirety of co-pending U.S. patent application Ser. No. 19/054,068, filed on Feb. 14, 2025, entitled “A LOGICAL CHANNEL FOR AN AI/ML PLANE” (having Attorney Docket No. 2024-2286_7785-3828), which is commonly assigned with the present application. This co-pending application provides detailed descriptions and embodiments related to the AI/ML Control Channel (AMCCH).

Further, a General Packet Radio Service (GPRS) Tunneling Protocol (GTP) based interface, GTP-AM 212, is established between the RAN 202 including gNB 208 and the core network 204, including core functions such as NWDAF, DCCF, and ADRF. See co-pending U.S. patent application Ser. No. 19/054,087 (having Attorney Docket No. ATT/P/2024-2283/US/ORG/0_7785-3826A) filed on Feb. 14, 2025, and commonly assigned with the present application, which is incorporated herein in its entirety by this reference. GTP tunnels may connect a UE such as UE 206 to a gNB such as gNB 208 and a gNB such as gNB 208 to the core network 204. GTP is used to carry data and signaling traffic between different parts of the network. GTP creates virtual tunnels between different network elements such as between a gNB 208 and the NWDAF 210, allowing them to communicate with each other. This is well adapted for carrying user data and control signals. GTP carries user data such as internet traffic between a user's UE device or UE 206 and the core network 204. The GTP also handles signaling messages, which may be used to control and manage connections, mobility, and other network functions.

However, in current 5G core networks (5GC), some core network functions such the Network Data Analytics Function (NWDAF) 210, Data Collection Coordination Function (DCCF) and the Analytics Data Repository Function (ADRF) support only Service-Based Interface (SBI). Generally, the 5G core network is designed with a Service-Based Architecture (SBA). Instead of traditional point-to-point interfaces, 5G utilizes a service-oriented approach. SBI defines how different network functions (NFs) within the 5G Core communicate with each other. This communication is typically based on web-based technologies, such as HTTP/2 and RESTful APIs. SBI is generally the set of rules that allow 5GC services to talk to each other efficiently.

Conventionally, a GTP-based interface such as GTP-AM is not supported in 5GC. If AI/ML data requires transportation from the RAN such as RAN 202 to the core network 204 through a GTP-based interface 212, non-trivial changes to the existing core network architecture are required. Thus, a technical problem exists in the communication of data between the RAN 202 and the core network 204. The GTP-AM interface is not readily compatible with the SBI communication that is standard to use in the core network 204. To this end, other methods are established for transporting the AI/ML data from the RAN to the CN, which leverages existing interfaces, and provides the benefit of a dedicated plane for communication of AI/ML data in the system 200.

FIG. 2B is a block diagram illustrating an example, non-limiting embodiment of a system 220 functioning within the communications network 125 of FIG. 1 in accordance with various aspects described herein. The system 220 enables communication of mobile communication data between the RAN 202 and the core network (CN) 204.

Similar to the RAN 202 of FIG. 2A, the RAN 202 of FIG. 2B includes multiple cell sites and multiple gNB devices such as gNB 208 which provide radio communication services to user equipment such as UE 206 located in a service area served by gNB 208. In addition, the RAN 202 includes one or more distributed units (DU) 208b and central units (CU) 208a along with a radio unit 208c and a service and management orchestration (SMO) function 208d.

The CU 208a serves as a logical node within the open radio access network (ORAN) architecture of cellular networks. The CU 208a hosts key protocol layers, including the Radio Resource Control (RRC), Service Data Adaptation Protocol (SDAP), and Packet Data Convergence Protocol (PDCP). The RRC layer is responsible for managing the connection between the user equipment (UE) and the network, handling tasks such as mobility management and connection setup. The SDAP layer maps Quality of Service (QoS) flows to data radio bearers, ensuring that data is transmitted with the appropriate QoS parameters. The PDCP layer provides header compression, encryption, and integrity protection, facilitating secure and efficient data transfer. The CU 208a communicates with the core network 204 and distributed units such as DU 280b to exchange information to manage radio resources and user sessions.

The DU 208b is a logical node within the ORAN architecture of cellular networks, responsible for hosting the Radio Link Control (RLC), Medium Access Control (MAC), and high Physical (PHY) protocol layers. The RLC layer provides error correction and data segmentation, ensuring reliable data transmission. The MAC layer manages resource allocation and scheduling, optimizing the use of available radio resources. The high PHY layer deals with the transmission and reception of data over the air interface, handling tasks such as modulation and coding. improved support for high-bandwidth applications. The DU 208b manages radio resources such as a radio unit (RU) associated with the gNB 208. The DU 208b operates as a baseband unit (BBU) to process baseband communication signals between the RU and the CU 208a, including both uplink (UL) and downlink (DL) signals. The uplink is the radio connection from the UE 206 to the gNodeB 208; the downlink is the radio connection from the gNB 208 to the UE 206. The DU 208b in combination with one or more RUs establishes a radio access network (RAN) for access by a subscriber unit or user equipment (UE) such as UE 206. The RU provides communications services to a coverage area near the RU for UEs such as the UE 206 in the coverage area.

The RAN 202 further includes one or more interfaces for communicating with the core network 204. A next generation (NG) interface is the logical interface that connects a Next Generation Radio Access Network (NG-RAN) such as RAN 202 to the 5G Core Network (5GC or CN) 204. The NG interface comprises a standardized set of communication protocols and procedures defining how the radio network and the core network interact. The NG interface includes a next generation-user plane (NG-U) 222 interface and a next generation-control plane (NG-C) 224.

The NG-U interface 222 connects the RAN to the user plane function UPF) 230 in the CN 204. The NG-U interface 222 carries user plane traffic. The NG-U 222 communicated encapsulated data packets. The standard protocol used over the NG-U interface is GPRS Tunnelling Protocol-User Plane (GTP-U), typically running over UDP/IP. GTP-U creates tunnels to separate and transport the data for different users and different data sessions (PDU Sessions). User data is encapsulated by the RAN 202 and forwarded over the NG-U interface 222 to the appropriate UPF such as UPF 230. The RAN 202 also receives downlink data from the UPF 230 via NG-U 222, decapsulates the downlink data, and sends it to the UE.

The NG-C interface 224 connects the RAN 202 including gNB 208 to the Access and Mobility Management Function (AMF) within the 5G Core (5GC or CN) 204. The NG-C interface 224 transports signaling messages related to connection and mobility management for User Equipment such a UE 206. The NG-C interface 224 generally manages the relationship and state of the UE concerning its access to the network including CN 204. The NG-C interface 224 carries signaling for a wide range of control procedures, including connection management, registration management, mobility management and others.

A further interface is provided by Operations, Administration, and Maintenance (OAM) server 226. The OAM server 226 may be instantiated in the RAN 202 when the RAN is implemented as an ORAN architecture. ORAN networks employ a disaggregated architecture of distinct hardware and software components with open interfaces. The interfaces are defined, for example, between an RU, a DU, a CU and the OAM. The ORAN may further include a Service Management and Orchestration (SMO) function 208d which provides overall management, orchestration and automation of the ORAN network elements and services. The OAM server 226 is not a specific interface like the NG-C interface 224 or the NG-U interface 222, but rather a broad functional area encompassing activities, tools, procedures, and protocols required to manage, monitor, control, and maintain the 5G network of system 220 to ensure it operates efficiently, reliably, and meets performance expectations.

In the core network 204, the UPF 230 is in data communication with the RAN via the NG-U interface 222. The User Plane Function (UPF) receives uplink data from the NG-RAN node via the NG-U interface 222, decapsulates it, potentially applies policies (like Quality of Service, QoS) or inspection, and routes the uplink data towards external data networks such as the public internet. For downlink traffic, the UPF 230 receives data from the external network, encapsulates it using GTP-U, and sends the downlink data to the correct NG-RAN node via the NG-U interface 222.

The UPF 230 routes AI/ML traffic between the UE 206 and gNB 208 and network elements of the core network 204. The UPF 230 uses an N3 interface between the gNB 208 in the RAN 202 and the UPF 230. The UPF 230 uses an N6 interface to connect to the Data Network (DN), which could be the internet, a private network, or other external networks. Other UPF interfaces are specified and used as well. In particular examples, AI/ML related traffic is either generated at user equipment such as the UE 206 and then forwarded to a RAN node such as the gNB 208 or generated at the gNB 208, and then the AI/ML data is routed towards the core network 204. In embodiments, User Plane (UP) AI/ML traffic is routed from the gNB 208 through the NG interface. In particular, the user plane AI/ML traffic is routed via the N3 interface of the NG-U interface 222.

The Access and Mobility Function (AMF) 232 is a primary point of contact in the core network 204 for all control plane signaling of UE 206. The AMF 232 manages registration of devices such as the UE 206 in the network as well as managing connections of the UE 206 to the RAN 202, mobility of the UE 206 and authentication and authorization. When a UE initially connects to the network, the gNB selects an appropriate AMF to handle the UE's control plane signaling. This selection can be based on factors like UE location, network slice requirements, and AMF load.

The AMF 232 routes AI/ML traffic between the UE 206 and gNB 208 and network elements of the core network 204. For communication with other network elements, the AMF 232 includes an N1 interface between the UE 206 and the AMF 232, a N2 interface between the gNB 208 of the 5G RAN 202 and the AMF 232. Other AMF interfaces are specified and used as well. As noted, AI/ML related traffic is either generated at user equipment such as the UE 206 and then forwarded to a RAN node such as the gNB 208 or generated at the gNB 208, and then the AI/ML data is routed towards the core network 204. In embodiments, Control Plane (CP) AI/ML traffic is routed from the gNB 208 through the NG interface. In particular, the user plane AI/ML traffic is routed to the Access and Mobility Function (AMF 232) via the N2 interface of the NG-C interface 224.

AI/ML related traffic from a UE such as UE 206 and forwards a gNB or generated at the gNB-CU/gNB-DU in the case of use of an ORAN architecture, the AI/ML data is then forwarded through Management Plane (M-Plane) to the core network 204. The M-plane is a data communication plane for managing data among elements of the ORAN architecture such as the DU, RU, CU and the OAM 226. The primary protocol used on the M-plane interface is NETCONF (Network Configuration Protocol) over Ethernet with IP. Communication between the OAM 226 and the RU, the DU, the CU and particular functions of the core network 204 may be according to any suitable interface including vendor-specific interfaces.

In embodiments, the system 200 further includes an Intelligent Traffic Steering and Throttling Agent (ITSTA) 228. The ITSTA 228 selects or decides the path through which the AI/ML traffic traverses the CN or core network 204. As noted, when the AI/ML traffic enters the core network 204 from the RAN 202, the AI/ML traffic has multiple options to choose from. These include communication via the N3 interface, via the N2 interface or using the M-plane. The ITSTA 228 decides which path the AI/ML traffic shall choose. This includes selecting a path within the RAN 202 such as between a DU 208b and the CU 208a as well as selecting a path between the RAN 202 and the core network 205.

The decision by the ITSTA 228 to choose a path for the AI/ML data to the core network 204 can be taken based on any suitable factor. Some exemplary factors may include, but are not limited to, a device type of the UE 206 or the gNB 208; a category of device or data; data volume of the data to be communicated, an assigned priority of the service flow, etc. For example, the data flow to the UE 206 may be assigned a relative high-priority Quality Class Identifier (QCI) based on an assigned Quality of Service (QoS) level for the data flow. In a particular example, data communications of first responders in a first responder data network are given a relatively high priority. Such high-priority data may be given a particular handling by the ITSTA 228 based on that high priority.

In another example, a first UE may be a smartphone engaged in conventional text and data communication; a second UE may be an internet of things (IoT) implemented as a sensor, periodically reporting data back to a data network through the RAN 202 and the core network 204; a third UE may be a virtual reality (VR) headset actively engaged in an online game, exchanging data at a high rate and requiring very low network latency. Each of these UEs may be assigned a particular path for its AI/ML data by the ITSTA based on its category or device type (handset versus IoT device versus VR headset) or its volume of data (minimal for the IoT device and substantial for the VR headset).

When the ITSTA 228 decides to route the AI/ML traffic through the UP of the core network 204, the AI/ML traffic from the gNB 208 of the RAN 202 is routed to the UPF 230 through the N3 interface. As with all traffic that crosses the N3 interface, GTP-U tunnels are used to carry the AI/ML traffic. Before that, the proper QoS markings are decided for the AI/ML traffic and the corresponding QoS Flow Identifier (QFI) is added to the GTP-U header. In addition, an on-demand PDU session and data connection are established to route the traffic through the UP. A protocol data unit (PDU) data session represents a logical connection between a UE such as the UE 206 and a data network like the public internet. The PDU session is the end-to-end tunnel that carries the user's data traffic. One way to realize this is using a subscribed or dedicated AI/ML-Data Network Name (DNN) for AI/ML related traffic. When network traffic associated with the specified AI/ML DNN is received by the core network 204, the core network 204 knows that the traffic is AI/ML related and may route the traffic accordingly.

Once the UPF 230 receives the AI/ML traffic, the UPF 230 exposes the data to the NWDAF 210 (or DCCF or ARDF) through the network exposure function (NEF), which leverages the SBI. The NEF enables the secure and controlled exposure of network capabilities and services to authorized application functions (AFs). The NEF interacts with other AFs using SBI connections. The UPF could expose such AI/ML data to the NWDAF based on policy driven subscription and/or data management service.

If the ITSTA 228 decides to route the AI/ML traffic to the control plane of the core network 204, then the traffic in question is provided to the AMF 232 from the gNB 208. This traffic passes through the N2 interface, NG-C interface 224, and uses the NG application protocol (NGAP). NGAP is responsible for all control plane signaling exchanged between the gNB 208 and the AMF 232.

Once the AMF 232 receives the AI/ML traffic, it exposes the data to the NWDAF 210 (or DCCF or ARDF) through the network exposure functions (NEF), which leverages the SBI. In addition to the exposure of AI/ML data from AMF 232 to NWDAF 210 via NEF, the AMF 232 could also expose such data directly to the NWDAF 210 depending on the AMF analytics subscription management policies.

In another aspect, the ITSTA 228 may control and manage throttling of traffic. In a data network, traffic throttling is the intentional slowing down of data transfer rates for specific types of traffic, users, devices, or applications. The ITSTA 228 may implement throttling to manage network congestion, enforce policies, and optimize resource utilization. For example, the network carries user data and control data and, at times, the volume of user data and control data may require that the AI/ML data be given a lower priority or be suspended for a time or even rerouted to a different path. For example, the AI/ML data is unlikely to be mission critical, and in some cases such as training data, be constitutes a very large amount of data. In such cases, at the convenience and discretion of the network operator, the ITSTA 228 can be programmed to throttle or redirect AI/ML data in the RAN 202 or between the RAN 202 and the core network 204.

The ITSTA 228 continuously monitors the path within the RAN 202 or the path to the core network 204 that has been selected for transporting the AI/ML traffic. The ITSTA 228 may monitor any suitable traffic characteristic such as latencies, data transfer rates, and other factors. If a current load or other traffic characteristic on that chosen path exceeds a certain threshold, the ITSTA 228 may select to throttle the traffic as well as switch the selected path to an alternative selected path, assuming the availability of an alternative path. Any suitable threshold or combination of thresholds may be chosen, and dynamic thresholds may be used based on, for example, time of day.

In a further aspect, the ITSTA 228 also configures data collection parameters. In one example embodiment, when training data for a particular AI/ML model is being collected by an application for offline training of the model, collection of the training data is unlikely to be delay-sensitive and the training data can potentially be large in volume. On the other hand, in an alternative embodiment, the system 220 communicates AI/ML monitoring data associated with AI/ML functions. For example, once a model is deployed, the model's performance is monitored by collecting monitoring data. The monitoring may be to determine, for example, if the model should be tuned or updated or replaced. Such monitoring data is more likely to have a degree of delay sensitivity and may generally be smaller in volume compared to training data. For each of these embodiments, it may be expected that the data collection parameters shall be different. ITSTA 228 can configure these data collection parameters depending on a current scenario.

In an additional example, ITSTA 228 negotiates with the core network 204 on which subset of RAN data is required to be transported to core network 204. For example, if a function of the core network 204 requires data for further processing, the core function may not require all available data but a subset of the available data may be adequate. Based on the information of the ITSTA 228 about network traffic parameters, the ITSTA 228 may negotiate with the core function how much data to transfer.

The ITSTA 228 may be located at any suitable network location in the system 200. In one example, the ITSTA 228 may be located inside the SMO 208d. In addition, in a disaggregated RAN architecture, ITSTA can consider the performance metrics (e.g., latency) of the RAN transport network and recommend the path between the control plane of the DU 208b and the CU 208a, or between the user plane of the CU 208a that AI/ML traffic shall take. The ITSTA 228 may be embodied as any suitable data processing system including a processor and memory. The ITSTA 228 may be incorporated functionally in other equipment such as the CU 208a, the DU 208b, or may be separately implemented on a network slice in a virtual network configuration.

In addition to managing routing of AI/ML data in the system 200, the ITSTA 228 may collect information about network operation. Such information may in turn be used to make routing and throttling decisions for AI/ML data. For example, the ITSTA 228 may receive any suitable network traffic data including information about traffic volumes in particular traffic branches or network elements, current latency values in particular traffic branches or network elements, and other information. Generally, the RAN 202 and the core network 204 maintain a large number of key performance indicators which characterize network performance. The ITSTA 228 may receive or have access to any of this data, or other potentially useful data, for making routing decisions for AI/ML traffic.

In some embodiments, the ITSTA 228 may be embodied as an artificial intelligence or machine learning model. Any suitable model may be chosen. In a particular example, the model may have access to both current network KPI data and historical KPI data. Based on the available data, the ITSTA 228 in this embodiment may be able to predict a best option for routing particular AI/ML data between the RAN components and the core network 205.

FIG. 2C is a block diagram illustrating conventional communication interfaces in a mobile communications system 240. The mobile communications system 240 may implement ORAN functions of a RAN 202 embodied in an ORAN architecture. The RAN 202 includes an RU such as RU 208c and communicates with a service management and orchestration framework (SMO) 208d using an O1 interface 244. The O1 interface 244 is a logical connection between the SMO 2085d and the O-RAN Managed Elements (MEs) such as the RU, DU and CU. One purpose of the O1 interface 244 is to enable comprehensive OAM functionalities for the O-RAN components. The O1 interface in ORAN uses the M-plane for managing the O-Radio Unit (O-RU) 208c. Further, the RAN 202 communicates with the 5G core network 204 over an NG interface.

An interface 246 enables communication between the SMO 208d and the core network 204. In a particular example, the AI/ML data that is collected by the RAN 202 is stored in an OAM entity, which is part of the SMO 208d. Any suitable data storage entity may be selected including a combination of data storage elements of the system 240. The connection to the OAM from the gNB (O-CU or O-DU) is through the O1 interface 244. The O1 interface is as usual configured using NETCONF or RESTCONF. The AI/ML data in OAM, i.e., in the SMO 208d, is transferred to the core network 204 over the interface 246. This interface 246 between the SMO 208d and the core network 204 is presented in the O-RAN architecture is currently out of scope for O-RAN standardization.

In the exemplary embodiment, the ITSTA 228 is in data communication with the interface 246 to receive control plane, user plane and AI/ML plane data of the O-RAN network functions of the RAN 202. The ITSTA 228 further may receive network traffic and status data. Based on the received information, the ITSTA 228 decides which path the AI/ML traffic shall choose. As noted, the decision of choosing a core network 204 path for the AI/ML data can be taken based on any suitable factor including for example, device type, category, data volume, priority of the service flow, etc. Further as noted, the ITSTA 228 may be located any suitable location in the system 240. In one example, the ITSTA 228 is located inside the SMO 208d or integrated with other functionality of the SMO 208d. Still further, the ITSTA 228 may consider the performance metrics (e.g., latency) of the transport network of the RAN 202 and recommend a path between selected O-RAN network functions such as the O-DU and O-CU-CP or O-CU-UP for AI/ML traffic.

FIG. 2D depicts an illustrative embodiment of a method 250 in accordance with various aspects described herein. In particular, FIG. 2D illustrates method 250 for transporting AI/ML data within a mobile network. The method 250 begins with step 252, where AI/ML data is received from the radio access network RAN 202. In the example, of FIG. 2A, the RAN 202 includes user equipment UE 206 and a gNB 208, which facilitate the initial collection and transmission of AI/ML data. The AI/ML data is then routed through the AI/ML radio bearer (AMRB) of the connection 214 and AI/ML control channel (AMCCH) of the connection 214, as depicted in FIG. 2A.

In step 254, the method 250 includes determining the appropriate transport pathway for the AI/ML data. This decision may be controlled by the Intelligent Traffic Steering and Throttling Agent (ITSTA) 228, as shown in FIG. 2B. The ITSTA 228 evaluates factors such as device type, data volume, and service flow priority to select the optimal pathway from the available options, including the user plane path via the NG-U interface 222, the control plane path via the NG-C interface 224, and the management plane path via the OAM server 226.

Step 256 involves routing the AI/ML data over the selected pathway. This step corresponds to the transmission of data through the chosen interface, whether it be the NG-U interface 222 to the user plane function (UPF) 230, the NG-C interface 224 to the access and mobility function (AMF) 232, or the management plane path to the OAM server 226, as illustrated in FIG. 2B.

At step 258, the method includes determining if the traffic exceeds a predetermined threshold. Any characteristic of network traffic, such as traffic volume, traffic throughput or data rate, packet loss, or latency, may be used. Moreover, any suitable threshold may be used for comparison. In general, the ITSTA 228 continues to monitor performance of the delivery of AI/ML data through the network and respond accordingly. If the network load is too high, the ITSTA 228, as depicted in FIG. 2B, intervenes to manage the traffic flow and ensure network stability.

In step 260, if at step 258, the traffic exceeds the threshold, a new pathway is selected. For example, the ITSTA 228 dynamically reselects an alternate pathway based on the current network conditions and the factors considered in step 254.

Finally, at step 262 further AI/ML data is routed over the new pathway, ensuring efficient data transport and minimizing disruption to existing network services.

Overall, FIG. 2D demonstrates the method 250 for transporting AI/ML data within the mobile network, leveraging the components and interfaces depicted in FIGS. 1, 2A, 2B, and 2C to optimize data handling and network performance.

The illustrated system and method provides many benefits. For example, the illustrated embodiments ensure that the core network of the cellular network remains largely the same or unchanged from current implementations. The illustrated approach is less disruptive to the existing core network architecture and as a result, easier for adoption. In some embodiments, the Intelligent Traffic Steering and Throttling Agent (ITSTA), which decides the path, among the UP, the CP, and the M-Plane, that the AI/ML traffic should take when it traverses the core network. Additionally, the ITSTA monitors and detects whether the load on the existing planes (i.e., UP, CP, and Management plane) is exceeding a pre-defined threshold due to the AI/ML traffic and accordingly, throttles that traffic. Such throttling may be done partially or completely or may include rerouting data.

In the illustrated embodiments, the ITSTA 228 has been shown in conjunction with a cellular radio access network. In addition, in other embodiments, the functions and structure of the ITSTA may be extended to other types of access networks. For example, the ITSTA can support different types of access networks including cellular, Wi-Fi networks, satellite networks, etc., as well as fixed wireless networks. The ITSTA can manage routing of AI/ML traffic from different access networks to a unified 3GPP core network which serves multiple access networks.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

From the foregoing, it can be seen that the exemplary system and method enable transporting AI/ML data within a mobile network by leveraging existing network interfaces and paths, thereby minimizing disruption to the current network architecture. Unlike previous solutions that required significant architectural changes, this method introduces an Intelligent Traffic Steering and Throttling Agent (ITSTA) to dynamically select the optimal path for AI/ML dWi-ata based on various factors such as device type and data volume. The ITSTA not only routes traffic through the User Plane, Control Plane, or Management Plane but also monitors network load to throttle traffic if necessary. This approach ensures efficient data transport while maintaining network stability and scalability, supporting various access networks and integrating seamlessly with both traditional architectures and O-RAN architectures. Additionally, the disclosed system and method enable the use of existing interfaces like the NG and O1 interfaces for data transport, which aligns with the industry's push towards automation and optimization using AI/ML, thus offering a scalable and cost-effective solution for AI/ML data management in mobile networks.

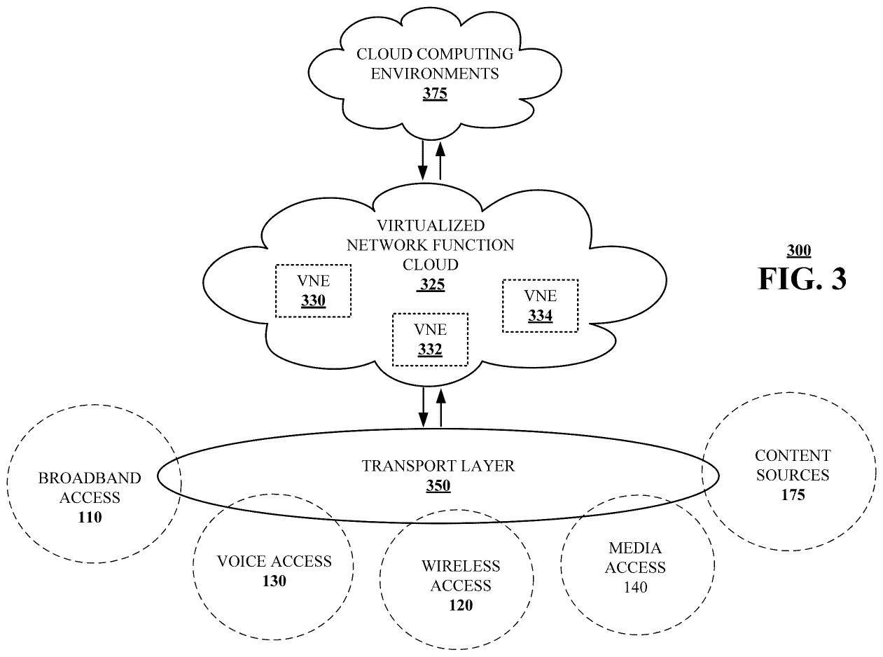

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, system 220, system 240 and method 250 presented in FIG. 1, FIG. 2A, FIG. 2B, FIG. 2C, FIGS. 2D and 3. For example, virtualized communication network 300 can facilitate in whole or in part transporting AI/ML data between an access network such as a radio access network and a core network using existing interfaces and paths.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. At other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

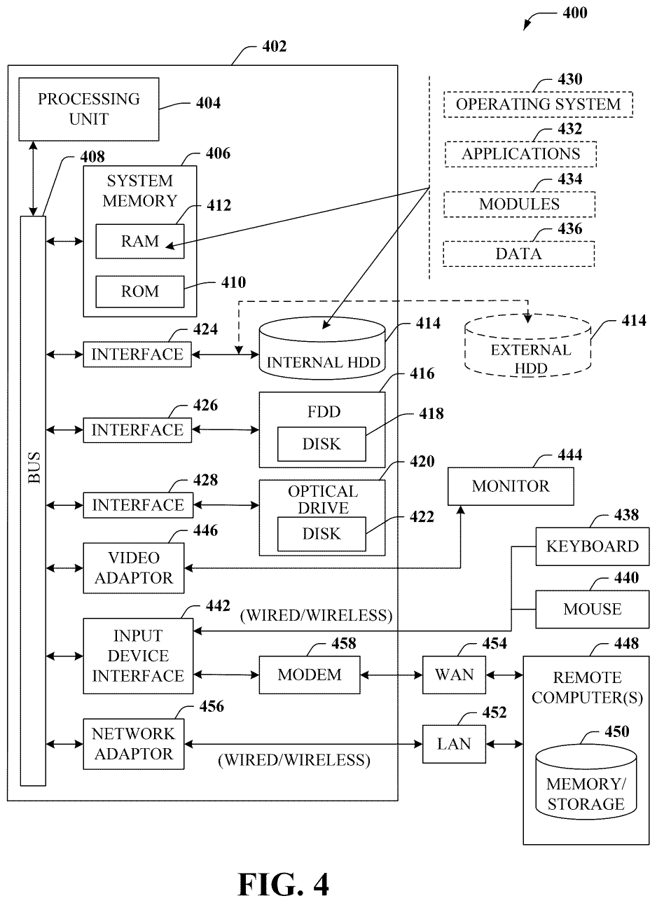

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part transporting AI/ML data between an access network such as a radio access network and a core network using existing interfaces and paths.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

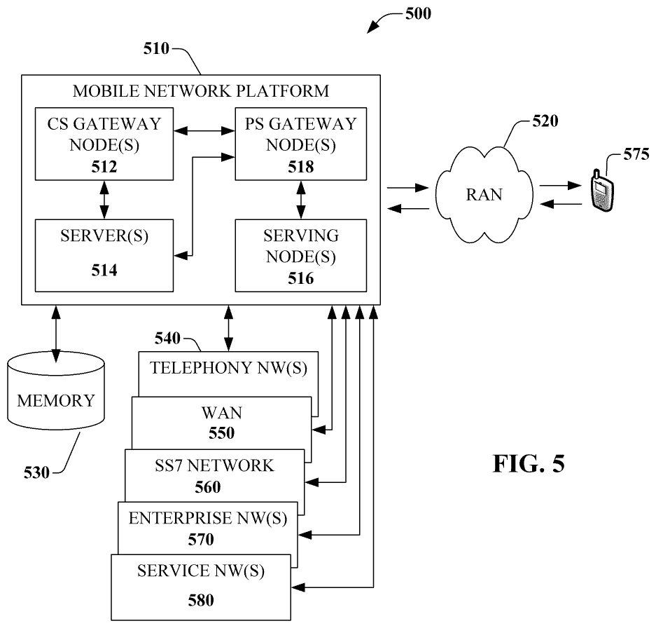

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part transporting AI/ML data between an access network such as a radio access network and a core network using existing interfaces and paths. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

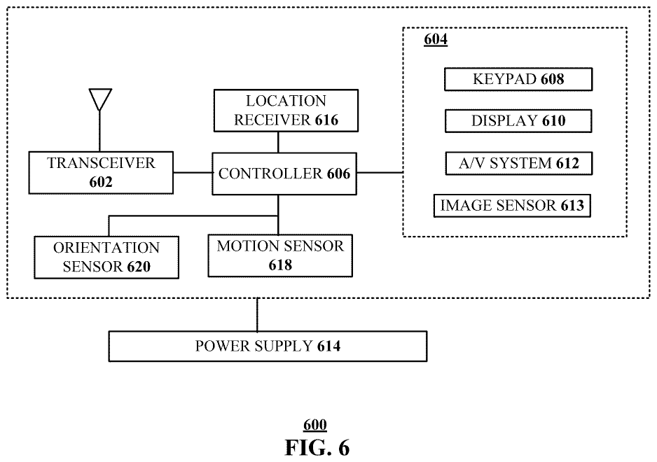

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part transporting AI/ML data between an access network such as a radio access network and a core network using existing interfaces and paths.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth^{®}, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . aₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving artificial intelligence and machine learning (AI/ML) data from a network element in a radio access network (RAN) for communication to a core network (CN);
determining a transport pathway for the AI/ML data based on one or more factors, wherein the determining a transport pathway comprises selecting a selected transport pathway from among a plurality of available pathways, the plurality of available pathways including a user plane path, a control plane path, and a management plane path; and
transmitting the AI/ML data from the network element to the CN over the selected transport pathway.

2. The device of claim 1, wherein the determining the transport pathway for the AI/ML data comprises:
determining the transport pathway for the AI/ML data based on one or more of a device type, a data volume, a service flow priority, a time of day, a transport pathway priority, and network performance metrics.

3. The device of claim 1, wherein the operations further comprise:
monitoring a network load on the selected transport pathway;
reselecting an alternate transport pathway from the plurality of available pathways, wherein the reselecting the alternate transport pathway is responsive to a determination that the network load exceeds a predetermined threshold; and
transmitting subsequent AI/ML data to the core network along the alternate transport pathway.

4. The device of claim 3, wherein the reselecting the alternate transport pathway from the plurality of available pathways comprises:
reselecting an alternate transport pathway from the plurality of available pathways based on at least one factor of the one or more factors.

5. The device of claim 3, wherein the operations further comprise:
receiving information about network performance metrics;
comparing one or more network performance metrics to a predetermined threshold; and
throttling communication of the AI/ML data based on the comparing.

6. The device of claim 5, wherein the receiving information about network performance metrics comprises:
monitoring one of network latency, packet loss and throughput, or a combination of these.

7. The device of claim 1, wherein the operations further comprise:
identifying a current operational mode, wherein the current operational mode comprises one of a training mode for training an AI/ML model, and a monitoring mode for monitoring performance of the AI/ML model, and a model transfer mode; and
selecting data collection parameters, wherein the selecting the data collection parameters is based on the current operational mode.

8. The device of claim 1, wherein the operations further comprise:
selecting the user plane path of the CN for transmitting the AI/ML data to the CN;
adding appropriate Quality of Service (QoS) information to the AI/ML data, forming AI/ML data packets;
encapsulating the AI/ML data packets within a GTP-U tunnel; and
routing the AI/ML data packets from a base station of the RAN to a user plane function (UPF) of the CN through a N3 interface.

9. The device of claim 1, wherein the operations further comprise:
selecting the control plane path of the CN for transmitting the AI/ML data to the CN; and
routing the AI/ML data from a base station of the RAN to an Access and Mobility function (AMF) of the CN through a N2 interface.

10. The device of claim 1, wherein the operations further comprise:
selecting the management plane path of the CN for transmitting the AI/ML data to the CN; and
routing the AI/ML data from a base station of the RAN to an Operations, Administration, and Maintenance (OAM) server of the CN.

11. A non-transitory machine-readable medium, comprising executable instructions that, when executed by a processing system including a processor, facilitate performance of operations, the operations comprising:
receiving artificial intelligence and machine learning (AI/ML) data from a network element in a radio access network (RAN), the AI/ML data being generated by at least one of user equipment or a base station, the RAN being in data communication with a core network (CN) over a user plane path and a control plane path;
determining a selected transport pathway for conveying the AI/ML data from the RAN to CN, wherein the determining the selected transport pathway comprises selecting one of the user plane path and the control plane path; and
transmitting the AI/ML data from the network element to the CN over the selected transport pathway.

12. The non-transitory machine-readable medium of claim 11, wherein the determining the selected transport pathway comprises:
selecting the selected transport pathway based on one or more factors including a device type, data volume, service flow priority, a time of day, a transport pathway priority, and network performance metrics.

13. The non-transitory machine-readable medium of claim 11, wherein the operations further comprise:
monitoring performance metrics for data communication in the RAN and between the RAN and the CN; and
dynamically reselecting an alternate transport pathway among the user plane path and the control plane path when the performance metrics exceed a predetermined threshold.

14. The non-transitory machine-readable medium of claim 13, wherein the operations further comprise:
based on the performance metrics, throttling communication of the AI/ML data to improve overall data communication performance.

15. The non-transitory machine-readable medium of claim 11, wherein the operations further comprise:
identifying a current operational mode, wherein the current operational mode comprises one of a training mode for training an AI/ML model operating in the RAN, a monitoring mode for monitoring performance of the AI/ML model and a model transfer mode for transferring model data; and
selecting data collection parameters, wherein the selecting the data collection parameters is based on the current operational mode.

16. A method, comprising:
receiving, by a processing system including a processor, artificial intelligence and machine learning (AI/ML) data from a network element in a radio access network (RAN), the AI/ML data being generated by at least one of user equipment or a base station, the RAN being in data communication with a core network (CN) over a user plane path and a control plane path;
determining, by the processing system, a selected transport pathway for conveying the AI/ML data from the RAN to the CN, wherein the determining the selected transport pathway comprises selecting one of the user plane path and the control plane path;
transmitting, by the processing system, the AI/ML data from the network element to the CN over the selected transport pathway; and
throttling, by the processing system, communication of the AI/ML data to improve overall data communication performance, wherein the throttling is responsive to performance metrics for data communication between the RAN and the CN.

17. The method of claim 16, comprising:
monitoring, by the processing system, performance metrics for data communication in the RAN and between the RAN and the CN; and
reselecting, by the processing system, an alternate transport pathway among the user plane path and the control plane path when the performance metrics exceed a predetermined threshold.

18. The method of claim 17, wherein the monitoring performance metrics comprises:
monitoring, by the processing system, one of network latency and throughput, or a combination of these; and
monitoring, by the processing system, a network load on the selected transport pathway.

19. The method of claim 16, comprising:
determining, by the processing system, the selected transport pathway for conveying the AI/ML data from the RAN to the CN, wherein the determining the selected transport pathway comprises selecting one of the user plane path, the control plane path, and a management plane (M-plane) path.

20. The method of claim 16, comprising:
identifying, by the processing system, a current operational mode, wherein the current operational mode comprises one of a training mode for training an AI/ML model operating in the RAN, a monitoring mode for monitoring performance of the AI/ML model and a model transfer mode for transferring model data; and
selecting, by the processing system, data collection parameters, wherein the selecting the data collection parameters is based on the current operational mode.
